(19) United States
(12) Patent Application Publication
(10) Pub. No.: US 2026/0246608 A1
(43) Pub. Date: Aug. 20, 2026

(54) Hiding-in-Plain-Sight (HIPS) Cryptography

(71) Applicant: Gideon SAMID, Rockville, MD (US)

(72) Inventor: Gideon SAMID, Rockville, MD (US)

(21) Appl. No.: 19/054,913

(22) Filed: Feb. 17, 2025

(51) Int. Cl. H04L 9/06

(52) U.S. Cl. CPC H04L 9/0618

(57) ABSTRACT

A system and a method to build a recovery capability for a compromised network based on user controlled ad-hoc randomness combined with simplicity; immunized against stealth cryptanalysis which overshadows the prevailing security solutions. Using a randomized polar lattice geometry as a secret arrangement for the key bits, to approach one-time-pad security through built-in equivocation.

This Application is also a continuation in part of U.S. patent application Ser. No. 18/227,694 filed 2023 Jul. 29. This application is also a continuation in part of U.S. patent application Ser. No. 17/744,777 filed May 16, 2022. This application is also a continuation in part of U.S. patent application Ser. No. 17/510,324 filed Oct. 25, 2021, and it is also a continuation in part of U.S. patent application Ser. No. 17/216,274 filed Mar. 29, 2021, and also continuation in parts of U.S. application Ser. No. 17/001,163 filed 2020 Aug. 24, and also a continuation in part of U.S. patent application Ser. No. 16/855,517 filed Apr. 22, 2020, which is a continuation of application Ser. No. 16/687,690, which is a continuation of application Ser. No. 16/444,892.

THIS DEFINES A CONTINUATION ZONE ENCOMPASSING THE CURRENT APPLICATION AND application Ser. No. 18/227,694, 17/744,77, 17/510,324, 17/216,274, 17/001,163, 16/855,517, 16/687690, 16/444.892, AND ALL THE PROVISIONAL APPLICATIONS REFERENCED IN application Ser. No. 16/444,892, CROSS REFERENCED HERE:

This application claims benefits of Provisional Application No. 63/759,229 filed 2025 Feb. 16 Also CROSS REFERENCE TO PROVISIONAL APPLICATIONS No. 63/467,624 filed 2023 May 19; Provisional Application #63521825 filed 2023 Jun. 19. Provisional Application #62688387 filed on Jun. 22, 2018; Provisional Application No. 62/689,890 filed on Jun. 26, 2018; Provisional Application #62714735 filed on Aug. 5, 2018; Provisional Application No. 62/782,301 filed on Dec. 19, 2018; Provisional Applications No. 62/805,369 filed on Feb. 14, 2019; Provisional Application No. 62/813,281 filed on Mar. 4, 2019; Provisional Application No. 62/782,301 filed on Dec. 19, 2018; Provisional Application No. 62/813,281 filed 4th of March 2019; Provisional Application No. 62/850,720, filed May 21, 2019; Provisional Application No. 62/857,898 filed 6th June 2019. Provisional application 63/140,006 filed 2021 Jan. 21; #63306501 filed 2022 Feb. 4, #63/292,954 filed 2021 Dec. 22, #63/276,662, 2021 Nov. 8 and #63306501 filed 2022 Feb. 4.

STATEMENT REGARDING FEDERALLY SPONSORED RESEARCH OR DEVELOPMENT: Not Applicable.

REFERENCE TO SEQUENCE LISTING, A TABLE, OR A COMPUTER PROGRAM LISTING COMPACT DISK APPENDIX: Not Applicable.

### BACKGROUND OF THE INVENTION

Privacy in cyber space requires cryptographic means that help users conceal the occurrence of their secret communication, not just its contents. Ciphers as listed in the continued applications are well geared to provide such measure of privacy.

### BRIEF SUMMARY OF THE INVENTION

The ciphers listed in the continued applications are of a class of ciphers described as decoy-tolerant. Namely these ciphers can be given a ciphertext that contains content-bearing bits and noise-bits, and where the decoy-tolerant cipher will distinguish between them. This invention takes these continued ciphers one step further, and applies them for the purpose of hiding another message in the ciphertext of a first message. This methodology will allow one to use these ciphers to communicate a plain message which hides in it (in plain sight) a second message—which stays secret. The reader of the plain message will not have any indication that a secret message is packed into it stealthily. In summary, this enhanced protocol of the ciphers invented in the prior applications will offer a higher degree of privacy to its users.

### BRIEF DESCRIPTION OF DRAWINGS

### FIG-1: Hidden in Plain Sight Cryptography

This figure shows the overall scheme of HIPS. Two communicators working through their work stations, communicating through the Internet (the shown cloud). The transmitter of the hidden-in-plain-sight secret has a work station including CTP—clear text processor which takes in typed or entered text and creates a respective ciphertext based on a given key. The station may also have an artificial intelligence processor AIP that uses AI tools to generate clear text to support the HIPS operation. The station will have also the PTP—the payload text processor into which the transmitter submits their secret message (the payload). The work station also includes the integrator module (Integ) that combines the output from the clear text processor, the AI processor and the payload processor, all to create the armed communication package, fit for safe release through insecure channel aimed at a recipient who is also equipped with a computing device which includes the separator (Separ) which separates the payload from the decoy (clear text). The clear text may have some utility and in that case it is displayed to at the recipient work station, but it may be without utility and not displayed. The payload certainly has utility and it goes to the CTP to be displayed

### Fig-2 Flat Decoy HIPS

This figure shows how a payload bit string is cut into slices. The slices are injected with decoy bits to form a large bit string. AI is used to come up with identities for the fixed sized decoy-injections between the slices such that the combined bit string (slices+decoy) reads as an innocent text. The reader knows the size of the slices and the size of the decoy injections and so can extract the slices, concatenate them and reform the payload string. The smaller the slices and the larger the decoy strings the easier it is for the AI to come up with an innocent text hiding the secret payload slices.

### Fig-3 Binary P2P Encryption

This figure depicts binary mode P2P (plaintext to plaintext) encryption. A plain message “abcd” is being encrypted with a decoy tolerant cipher using key K1, creating 4 ciphertext letters (darker blue), where each letter in the plaintext, P is encrypted to a different letter in the respective ciphertext (darker color). It is shown as P→C.

In parallel another plaintext message “a′b′c′d′” is encrypted by the same cipher only using a different key K2≠K1 resulting in cipher text C′, comprising the same number of letters as the corresponding plaintext.

The picture shows the payload example as an 8 bits long bit string: 01001101 which the transmitter is encrypting into the composite ciphertext C″ by adding the next letter from C when the corresponding bit in the payload shows 0, and adding the next ciphertext letter from C′ when the corresponding bit in the payload shows 1. So one by one the composite ciphertext is created, carrying the two open ciphertext C and C′ together with the secret payload expressed through the order in which C″ has been constructed.

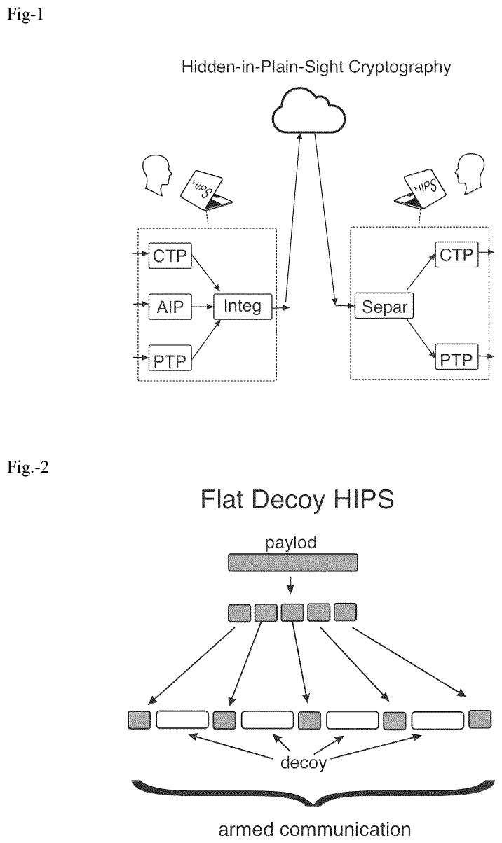

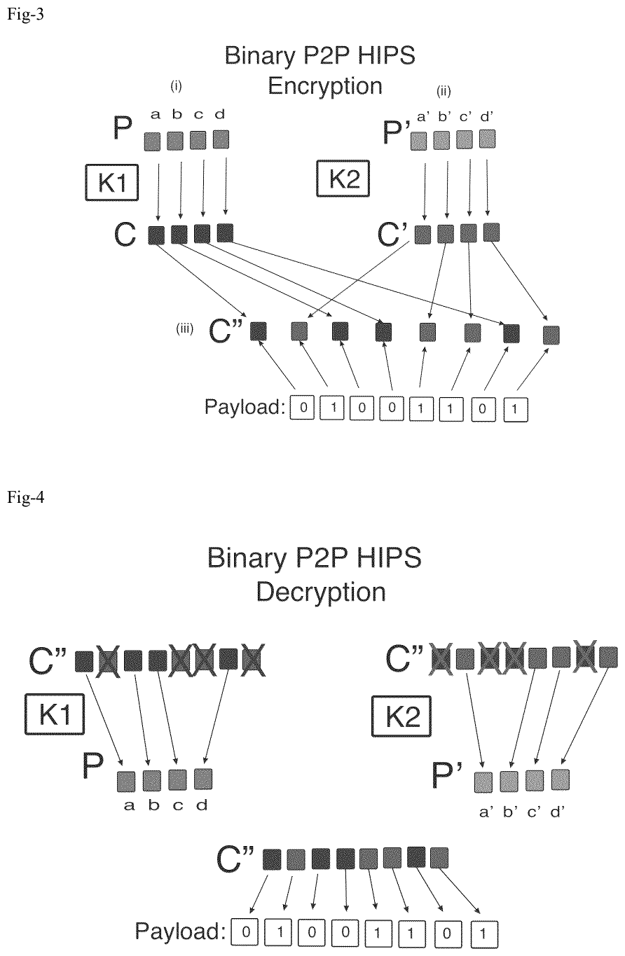

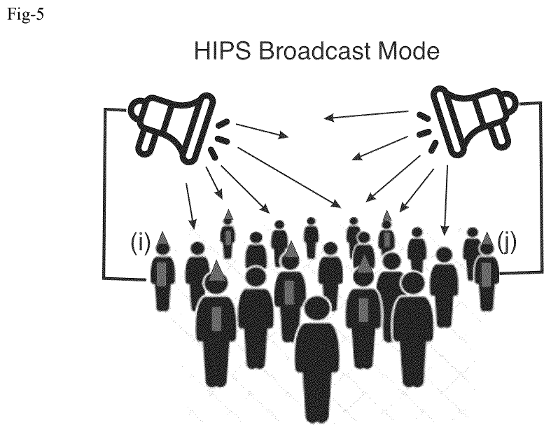

### FIG. 4. Binary P2P HIPS Decryption

This picture is continuation from Fig-3. It shows how C″ fed into the first cipher using K1 is discarding all the K2 letters and reading the letters from C one by one decrypting them through K1 and extracting the corresponding plaintext P. It also shows how the same C″ is processed through the same cipher but with key K2. Accordingly all the K1 letters are discarded in C″ and only the ciphertext letters from C′ are fed to the decryptor to extract the proper plaintext message P′. (a′b′c′d′)

The order of the K1 letters versus the K2 letters guides the reader to reconstruct the payload strong 01001101.

### Fig-5. HIPS Broadcast Mode

This figure depicts HIPS communication in a broadcast mode. A community of online surfers is shown, among them are members of a group G, they are marked with a pointed hat and a patch on the back. The figure shows member i of G broadcasting in cyberspace via a podcast, or a public channel or website. This clear text broadcast is downloaded and brought to the attention of many members of the public including members of group G. While member i may broadcast mostly empty rounds of HIPS where the clear text is the aim of the broadcast, member i may when needed hide an armed clear text-a clear text containing a HIPS secret. The public in general will not see a difference, but members of G will notice and will properly interpret the hidden payload secrets sent out to them by member i. In response member j of G will broadcast clear text j, which too will be downloaded by members of the public, among them members of G. Should member j reply to member i, member i will well receive the reply. And so members of G conduct a secret conversation in plain sight, covered by a conversation of clear text among them.

### DETAILED SPECIFICATION OF THE INVENTION

### Introduction

The ultimate privacy in communication is when a group of communicators can have a conversation, and not its contents, neither its occurrence is exposed against the will of the communicators. Proposing to achieve this state of ultimate privacy (UP) by allowing communicators to converse in the open (clear conversation) wherein the same communication encompasses a hidden conversation that does not expose its occurrence. This level of ultimate privacy is achieved to the extent that the clear conversation between the communicators by itself is not pointing to a hidden exchange. That means, if Alice and Bob have normal business conversation between them, they can hide in its exchange a hidden message—hidden in plain sight (HIPS) because there is no more than the clear exchange that runs between Alice and Bob, only that this clear exchange is so set up that it carries a hidden exchange. The efficacy of HIPS cryptography is hinged on (i) the extent that the clear conversation is not attracting scrutiny, or at least can be credibly denied as having any other purpose except what is evident from the nature and timing of the clear conversation, and (ii) on the extent to which the hidden conversation is so well hidden that an examiner of the clear conversation will find no evidence to the existence of the hidden message.

We will describe how to handle the first and the second challenge above. The first challenge is best handled via AI and via common procedures over the Internet. The second challenge is handled two ways: 1. flat decoy and 2. Plaintext to Plaintext cryptography (P2P).

### Spartacus

In the movie “Spartacus” is based on historical records, the Romans capturing the rebellions are trying to spot their leader, Spartacus. When they ask “Who is Spartacus?” all the rebels reply in unison “I am Spartacus!” keeping the Romans baffled. HIPS works the same. The payload secret is added to normal and proliferating communications without standing out, compelling an attacker to suspect any and all communication. Given that hidden secrets are a very tiny fraction withing the flood of Internet traffic, emails, messages, download, etc, this indistinction is a very effective tool, and a great contributor to privacy.

### Social Significance

Cyber space reality spells a powerful blow to the cause of privacy. We live in global visibility and global vulnerability state. Privacy is in shambles. This is a dangerous situation. Privacy is fundamental to freedom. The implementation of the technology described herein will allow any two or more people to hold a conversation in stealth while living in cyberspace. Stealth conversations is where new ideas emerge, where directions not sanctioned by the powers that be are identified and pursued. Progress, survival depends on this freedom to converse in robust privacy. One must admit, such freedom will enable the negative side of humanity to flourish: crime, war, terrorism, but arguably this is a price worth paying given how elemental privacy for good people is. Analogous to the 2nd amendment: the right to bear arms, regretfully, helps criminals, but it is wholeheartedly embraced as the ultimate defense of We The People.

### Operation

We describe ahead (i) the environment: aim, actors, means, (ii) dynamics. environment: aim, actors, means

A group G of g communicators wish to converse in cyber space in a state of ultimate privacy (UP state). UP state is defined as a state where messages within the group are not detected, not credibly suspected, and not deciphered.

UP state is achieved through establishing a front conversation within the group, and hiding the secret communication in plain sight, within the front conversation (clear text). To operate the group needs to (i) generate clear text fit for the purpose, (ii) fit the secret messages (payload) into the cleartext, (iii) extract the payload without attracting attention to the hidden text.

The underlying idea is that cyber space is flooded with normal clear text communication among billions of users. If every such mundane conversation can be pregnant with a payload of a hidden message then, it is virtually impossible for an adversary to focus on the very few which carry such a payload. In other words, the normalcy of the front exchange generates the UP state.

The actors then are the g members of group G, and the adversary who is assumed to have full access to cyber space traffic.

The means for the HIPS operation are (i) the HIPS word processor, (ii) the HIPS Secret Injector, (iii) the HIPS secret extractor.

The HIPS means are fitted into the computing machines of the members o G. The members are connected through the information highway, the Internet, and all their communication is assumed to be exposed to the adversary.

### HIPS Dynamics

The G group is sharing the HIPS protocol, and one or more secret communication keys, K. The key K is shared off line, securely. Alternatively the group can exercise one of many protocols that allow strangers to establish a secure shared secret. By so doing (for example using Diffie Hellman) two strangers will establish a private shared secret and use it as a key for an agreed upon decoy tolerant cipher to practice HIPS. This will enhance the security of say whistleblowers who alert a journalist offering a public key to get in touch with him.

As part of their engagement in cyber space any member of G, i, may wish to send another member j a message mᵢⱼ.

To that end member i needs to establish a “blanket communication” with j. This communication goes through communication platform like email, or a messaging service. When properly established, member i writes down the mᵢⱼ—the payload—onto their personal device, and then hits “send”.

When the send button is pushed, the payload combines with the blanket communication (also referred to as clear text), to establish the “armed communication”: blanket+payload. The armed communication is released to the information highway where adversaries monitor it. When armed communication arrives to the personal computer of member j of G, it first goes into the separator module which separates the blanket from the payload. If the blanket has any value, it is forwarded to j. The extracted payload is forwarded to the attention of j, which terminates the communication episode.

Member j symmetrically will communicate a message mⱼᵢ to member i, and so on—an ongoing conversation. Member i can send the same message to more than one member of G.

The protocol is designed to make the armed communication to look like the innocent blanket communication, attracting no attention to the hidden payload.

### Flat Decoy HIPS

This HIPS method is based on AI. The payload is broken to slices, which are separated by blanket data. The combined blanket bits and the payload bits read as an innocent message, and only the intended reader can remove the blanket bits and extract the payload. This payload may be plaintext or a ciphertext of another cipher.

This flat decoy bits (the blanket) operate by building the armed communication to project a perfectly innocent message. This is accomplished via trained AI that works out a normalized message that is built from the blanket bits and the payload slices.

Example: payload: 43297 in binary: 0100 0011 0010 1001 0111

The payload is cut to slices 4 bits long. each: 0100-0011-0010-1001-0111

The slices are placed at a distance of 16 bits one from the other:

$$[ 0100 ] - [ 16 decoy bits ] - [ 0011 ] - [ 16 decoy bits ] - [ 0010 ] - [ 16 decoy bits ] - [ 1001 ] - [ 16 decoy bits ] - [ 0111 ] - [ 16 decoy bits ] -$$

Now AI in unleashed to find a normalized text that will fill the decoy bits such that together with the payload the reading will be plain and suggesting no hidden secret.

AI will fill up the identity of the decoy bits such that the decoy bits plus the payload bits will amount to a normalized text, as below: readily come up with “How is the weather” which reads in binary as:

$$[ 0100 ] - [ 1000 \; 01101111 \; 0111 ] - [ 0011 ] - [ 01100101 \; 0111 \; 0010 ] - [ 0010 ] 0000 \; 01110100 \; 0110 - [ 1001 ] - [ 01101110 \; 01100111 ] - [ 0111 ] 0011$$

An attacker will see a plain statement, one of billions of the kind all over the Internet. But the intended reader will remove the decoy bits, will remain with the payload: 0100 0011 0010 1001 0111 which displays on the reader's screen as 43297.

The smaller the slices, and the larger the distance between them (in terms of decoy bits count) the easier it is for the AI module to find a benign text that will comply with the slices and their mutual distances.

The armed communication will look exactly as blanket communication. The text “How is the weather” is so common that in the normal course of communication it will appear innocently. Only when the reader is expecting a HIPS message, will they look for one.

### Plaintext to Plaintext (P2P) Cryptography

This HIPS method, P2P, is based on exploiting the flexibility built in into decoy tolerant ciphers. In P2P cryptography a plaintext P is encrypted with a key K to form a ciphertext C. The transmitter packs together [C,K] and sends the package out. Every recipient (intended or otherwise) will readily decrypt C back to plaintext P using the go-along key K. Since the employed cipher is decoy-tolerant, the transmitter can shape up C to hide a payload in it en route. The intended recipient will read P (of which he may have no interest), and extract the hidden payload that was interwoven into C.

We first describe a simple version of the P2P protocol, then extend it.

### Two Keys P2P HIPS Cryptography

Let E and E′ be two encryption modules of decoy tolerant cipher operating over a plaintext alphabet P* comprising n letters p₁, p₂, . . . pₙ, and over a ciphertext alphabet C* comprising m letters c₁, c₂, . . . cₘ, where every ciphertext letter maps into a specified plaintext letter, and all plaintext letters have at least one ciphertext letter pointing to them.

All the ciphertext letters are of the same size. E and E′ being “decoy tolerant” implies that if the ciphertext will include a decoy letter dⱼ that is different from all the ciphertext letters then the cipher will disregard it. That means that a ciphertext C comprising g C* letters, may be mixed with h decoy letters d₁, d₂, . . . dₙ defining a decoy string. This results in a decoy ciphertext Ca comprising g+h letters. When ciphertext Ca is processed by the matching decryption module of the cipher, D all the decoy letters will be ignored and the remaining g ciphertext letters will be deciphered each to their respective plaintext letter to reconstruct the original plaintext.

Let a message P be encrypted with a decoy tolerant cipher E using a key K, to generate a ciphertext C comprising g ciphertext letters. c₁, c₂, . . . c_{g}

Let a message P′ be encrypted with a decoy tolerant cipher E′ using a key K′ to generate a ciphertext C′ comprising g′ ciphertext letters. c′₁, c′₂, . . . c′_{g}′.

Let no letter in ciphertext C′ be the same as any letter from ciphertext C′, and let no letter from ciphertext C′ be the same as any letter from ciphertext C.

Letters in P may be shared with letters in P′.

Accordingly, if one builds a combined ciphertext C″ where the letters of ciphertext C and ciphertext C′ are mixed (while their order is maintained), then the decryption module D, using key K, will ignore the C′ letters and decrypt the letters from ciphertext C″ to plaintext P, while the decryption module D′ using key K′, will ignore the C letters in C″ and decrypt C″ into P′.

If one is sending C″ together with keys K and K′ to a recipient, then the recipient will decrypt C″ once to P (using K) and once to P′ (using K′), and so will anyone receiving the package of C″+K+K′.

This will hold regardless of the exact way the letters from C and the letters from C′ are being mixed (while order is preserved). Therefore the order of mixing of the letters from both alphabets can be used as an alphabet for a payload that would arm the communication.

### Payloading

Let ciphertext C be comprised of g ordered letters of the C alphabet: x₁-x₂ . . . x_{g}, and let ciphertext C′ be comprised of h ordered letters of the C′ alphabet y₁-y₂, . . . yₕ.

The combined ciphertext C″=C+C′ may be further mixed with f decoy letters z₁-z₂ . . . z_{f}:

$${C}^{⋀} = {C}^{″} + {C}^{d} = C + {C}^{′} + {C}^{d}$$

There are. (g+h+f)! ways to rearrange C\hat{ }. We are interested only in a fraction of them in which the order of the C letters and the order of the C′ letters is preserved. Namely we are interested in permutations of C\hat{ } wherein: for any pair of: xᵢⱼ; xₖₗ if i (k then j<l,
where xᵢⱼ is letter xᵢ placed in location j in C\hat{ }, and xₖₗ is letter xₖ placed in location l in C\hat{ }.

We construct C\hat{ } as follows:

We assign z₁₁—a decoy letter in position 1 on C\hat{ } (recall: there are g+h+f positions on C\hat{ }). Position 2 in C\hat{ } may be filled by x₁, y₁, or z₂. Whichever choice is made the next location on CA can be filled by the next x letter, or by the next y letter or by the next z letter. And so on as long as there are unassigned letters left. This points to a number of options, N, which is a bit smaller than:

$${3}^{g + h + f - I}$$

since at some points either x letters or y letters will be exhausted, and the threesome option for the next location on C\hat{ } will be reduced to two or one option.

We may denote a z-choice from any location forward with the digit 0, denote an x choice from any location as 1, and denote a y choice from any location as 2. Hence given z₁₁ any particular permutation of C\hat{ } can be described via a 3-based numeric system: in position writing it is a string comprising 0, 1, 2.

For example the string 21102 will be numerically:

$$2 * {3}^{4} + 1 * {3}^{3} + 1 * {3}^{2} + 0 * {3}^{1} + 2 * {3}^{0} = 200$$

In turn we write decimal 200 as π=11001000 binary. Hence the transmitter here could arm the blanket message C\hat{ } by rearranging the (g+h+f) letters to fit the 3-based string: 21102, and thereby inject into the blanket message the payload message 11001000, which is the ASCII representation for capital E.

This example shows how to inject the payload message E into the blanket message C\hat{ }.

The intended reader receiving C\hat{ } and the respective keys K₁=Kₓ and K₂=K_{y}, will be able to identify the x-letters, the y-letters and by default the z letters (every letter. that is not x type and no y type is z type). The reader will then read the “x message” P and the “y message” P′, and then interpret C\hat{ } as a 3-based numeric expression (z-0, x-1, y-2)—that's the payload. The reader will then translate the 3-based string to a binary string to generate the payload as binary. This binary message is the hidden message H. It can be a plaintext but it is better if it is any common encryption of a hidden message so that the injected payload appears random, not to attract attention.

An attacker will also use Kₓ and K_{y} which are packed into the ciphertext, read message P and P′ and even extract the payload. Finding the payload as randomized string the attacker will not know whether the trinary string is meaningless randomness, or it represents an encrypted message.

If the attacker suspects that the extracted payload is indeed payload they would have to find out what cipher was used to encrypt it and what key did that cipher employ, in other words to attempt to crack it. Of course, if the extracted string is empty randomness then the attacker will either not crack it or interpret it as a false message. Either way the attacker will not know whether they have broken the HIPS cipher or no (recall the HIPS cipher is the cipher used to generate the HIPS payload). This is especially daunting if the amount of communication between senders and recipients is large. Normally the communicators do business by exchanging P and P′ between them, only rarely will they inject a payload. The attacker will ‘drown’ in the volume of blanket, open communication between the communicators, not clear whether they exchange secret payload or not.

### Binary P2P

We can limit P2P to feature just two keys K, K′ and end up with two streams of ciphertext letters C and C′ which are mixed together with robust randomness, (keeping the original order), to form the composite ciphertext C″=C+C′. And so operating a large as possible volume of traffic.

In the event that a secret payload, π, is to be injected into C″ then the mix of letters will be modified as follows:

Let message X be expressed via n ciphertext letters x₁, x₂, . . . xₙ, and let message Y be expressed via m ciphertext letters m (n: y₁, y₂, . . . yₘ.

Let the payload secret message π be comprised of t bits. {0,1} t. b₁, b₂, . . . bₜ

The transmitter of X, Y and π construct C″ as follows:

c″ᵢ is the i-th letter in composite cipher C″.

$$If {b}_{1} = 0 then {{c}^{″}}_{1} = {x}_{1}$$

$$If {b}_{1} = 1 then {{c}^{″}}_{1} = {y}_{1}$$

$$If {b}_{2} = 0 then {{c}^{″}}_{2} = {x}_{2}$$

$$If {b}_{2} = 1 then {{c}^{″}}_{2} = {y}_{2}$$

And so C″ is being constructed from the x-letters and the y-letters, the general rule is as follows:

Let C″ at some point of its construction be built from q X letters and r Y letters. C″ at that point is a string of (u=q+r) letters. The selection of letter u+1 is carried out as follows:

$$If {b}_{u + 1} = 0 then {{c}^{″}}_{u + 1} = {x}_{q + 1}$$

$$If {b}_{u + 1} = 1 then {{c}^{″}}_{u + 1} = {y}_{r + 1}$$

This construction will continue until exhaustion: either the X-letters will be exhausted, or the Y letters will be exhausted, or the bits in the payload will be exhausted.

This means that for a larger payload (large t), the amount of clear text is to be expanded (higher q and r).

If no payload is injected, then a good randomization function RND should be applied:

$${{c}^{″}}_{u + 1} = RND ( {x}_{q + 1} , {y}_{r + 1} )$$

When C″ is analyzed by the recipient, x will be built as follows for i=1, 2, . . . t:

$$If {{c}^{″}}_{i} = {x}_{j} then {b}_{i} = 0 ( for some j )$$

$$If {{c}^{″}}_{i} = {y}_{j} then {b}_{i} = 1 ( for some j )$$

Thereby π will be reconstructed.

### Resource Planning

The open text is the resource that enables the HIPS operation. Sufficient text must be generated either through AI or manually.

Given a payload, x comprising t bits, r of them are 0 and q of them are 1 (r+q=t). It is being planned to transmit it in HIPS mode through a given decoy tolerant cipher. To that aim two keys will be used K1 and K2.

A cleartext of size t letters will be generated, either by AI or manually. The first r bits of which will be designated as plaintext 1 P1 and the other q bits will be designated as plaintext 2, P2.

P1 will be encrypted using K1 to ciphertext C1 comprising r ciphertext letters, and P2 will be encrypted using K2 to ciphertext C2 comprising q ciphertext letters.

The composite ciphertext C″ will be generated by taking in turn letters from C1 and C2 to reflect the identities of the payload π. This will ensure that there is enough cleartext to inject the payload into the combined ciphertext.

If the bit size of the ciphertext letter is w bits, then a t-bits payload will require t ciphertext letters written in wt bits, so w is the size factor of the armed communication versus the original payload.

### Encrypted Payload

The payload message may be plain and simply hidden in plain sight, relying on the volume of cleartext to keep it from wrong eyes. Albeit, for greater security and for ease of handling, it may be of advantage to pre-encrypt the HIPS secret so that the payload is the ciphertext that must be decrypted to the original HIPS secret for which all this apparatus is set forth.

We call the message for which we practice the HIPS as the HIPS secret, or ‘the naked secret’. By using what we will call a pre-encryption (pre-e) we generally assure that the payload will appear quite random, and so will not be distinguishable from empty randomness that is extracted from the cleartext.

Such projected confusion between empty randomness and content-full payload may also be required of the intended recipient. It is easy to do it by using for the pre-e a decoy tolerant cipher This will allow the intended recipient to distinguish between empty randomness and content bearing payload, while keeping the attacker confused.

### Multi Key P2P HIPS

Consider a decoy tolerant cipher with fixed size ciphertext letters. The cipher may be used via n distinct keys K₁, K₂, . . . Kₙ. Let the sequence of xᵢ₁, . . . xᵢ₂, . . . x_{ig1}, be the sequence of ciphertext letters which decrypt through Kᵢ to the corresponding plaintext message Pᵢ. This applies for i=1, 2, . . . n.

Let z₁, z₂, . . . z_{g0} be g₀ letters that don't decrypt to any plaintext message via any of the n keys.

Let C\hat{ } be a composite ciphertext that is built as a permutation of all the letters xᵢⱼ for all i=1, 2, . . . n, and for j=1, 2, . . . gⱼ plus the go z letters.

We restrict ourselves to C\hat{ } permutations in which for all i=1, 2, . . . n we have:

$${x}_{ijk} ; {x}_{ilr}$$

it holds that if j (l then k<r. Where xᵢⱼₖ is letter xᵢⱼ at position k in C\hat{ }, and xᵢₗᵣ is letter xᵢₗ in position r in C\hat{ }.

Namely the order of the letters that belong to a single message (out of the n) is preserved.

We can define any such C\hat{ } order by arbitrarily assigning z₁₁₁ as the first letter in C\hat{ } where z₁₁₁ is a letter z₁ appearing before all other z letters in C\hat{ }, and located in position 1 in C\hat{ }.

The cipher in use being decoy tolerant, any decryption of any letter in C\hat{ } that is not mapping into its respective plaintext alphabet using the engaged key, will be recognized as such and ignored. Hence a reader that is in possession of all the n keys will be able to identify each letter in C\hat{ } as to which key it belongs to or whether it is decoy letter. Hence the reader of CA equipped with K₁, K₂, . . . Kₙ will be able to map C\hat{ } in terms of a sequence of letters from all the keys. We designate wᵢ as a letter in C\hat{ } which maps through Kᵢ to a letter in the corresponding plaintext alphabet Pᵢ. Similarly w₀ will represent a decoy letter. Accordingly we can write C\hat{ } as:

$${C}^{⋀} = {w}_{{0}^{∞}} {w}_{{i}^{∞}} {w}_{{j}^{∞} …}$$

The first letter in C\hat{ } will be a decoy letter w′₀. The next letter may be another decoy or a letter from the n keys. Namely the next letter in C\hat{ } may be one out of n+1 possibilities. And for t letters in C\hat{ } the number of possible permutation for C\hat{ } is (n+1)^{t}. And if C\hat{ } is comprised of t+1 letters then C\hat{ } can be defined via a string W comprising the letters w₀, w₁, w₂, . . . wₜ,

Note that every time a letter xᵢⱼ is added to C\hat{ } it is after letter x_{i,j-1} has been added earlier. So there is no ambiguity as to the identity of the letters to build C\hat{ } from using the string W.

The string W amounts to representing numbers on the basis of n+1, hence W can be translated (mapped) to a binary string W→B.

Since we wish to use the HIPS cipher to inject a given payload (binary) message B*, we shall add a 1 on the left side of B* to capture any leading zeros in B* that would not be preserved if B* is mapped directly to a numeric value. Adding 1 to the left of B* will turn it into binary string B. B has a clear numeric value which can be expressed through a (n+1)-based string. Namely we can map B to its corresponding n—based expression: B→W.

W in turn can be used to construct string C\hat{ } such that it will hide in it the payload message B*

The intended reader will extract W from CA, map W→B→B* which is the binary form of the payload. This payload may be the encrypted version of the naked secret that this HIPS protocol is designed to protect.

The attacker will not know if the extracted W reflects a secret message or is meaningless randomness, and will not know which cipher and which key was used, if any, to generate W. That is how the communicators send messages under the cover of the n plain messages while the attacker does not know whether a message was sent and if yes, what was its contents.

### Deployment

We describe the following deployment options: (i) bilateral (ii) multilateral, (iii) broadcasting.

In all the modes one required HIPS compliant text processor.

### HIPS Compliant Text Processor

To operate properly the environment will need a HIPS compliant text processor, namely a processor that would take the text typed in or entered by the user, encrypt it with a designated decoy tolerant cipher, package it with the key used to encrypt it and then optionally add decoy letters and any other letters to the ciphertext which do not map into the plaintext corresponding to the particular key used. The ciphertext package C\hat{ }+K is then sent out to the recipient, which uses K to decrypt C\hat{ } by ignoring the decoy letters and decrypting only the valid ciphertext letters, then presenting the result on the screen or, say, for the consumption of the reader of the message. The sender then will type in or enter a message like it is done today using a regular word processor, and the reader will read the message on their screen as if the message was typed and communicated via a regular word processor and a regular communication apparatus.

The particulars of the HIPS operation are hidden from the writer and the reader. This operation is called plaintext to plaintext (P2P) operation because it does not produce a ciphertext challenging an attacker. After all, the key is packed together with the ciphertext. The encryption is used for the purpose of creating a defined sequence between a bona fide letter and a decoy and between bona fide letters from different keys, and using the order that is expressed by the sequence of different letter type in the combined ciphertext, in order to express an injected secret.

For HIPS to work on a broad basis HIPS compliant text processors will have to proliferate. The impetus to that is the edge they provide to the cause of privacy.

### Bilateral Deployment

Alice and Bob wish to establish a HIPS channel. To that aim they establish an open communication channel using a HIPS compliant text processor. They record a high level of open communication, then when the need arises they send to each other a secret payload. The payload itself may be encrypted through a decoy tolerant cipher so the reader can readily establish whether the extract payload candidate is a payload indeed or empty randomness.

Whenever the HIPS processor is used plainly without injecting a payload into it, then the construction of the C\hat{ } string should be done randomly to confuse the attacker as to whether it hides a payload or not.

An attacker monitoring Alice and Bob reading their open exchange will have no grounds to suspect that a secret message is hiding in plain sight. There is no other secret communication between Alice and Bob, everything they say to each other is through the HIPS processors. And if there is a suspicion based on some external circumstances then it cannot be substantiated.

### Muti Key Build up

Alice and Bob can use a multi key deployment. Namely they agree on n keys K₁, K₂, . . . Kₙ in order to give them a richer environment to express the payload message.

Let Alice prepare a long message M. Alice will slice M to n consecutive slices:

$$M = {m}_{{1}^{∞}} {m}_{2} … {m}_{n}$$

Section mᵢ for i=1, 2, . . . n. Alice will decrypt with key Kᵢ to generate the corresponding ciphertext cᵢ.

Alice will then mix the letters in c₁, c₂, . . . cₙ while preserving the original order as we have seen above, will add decoy letters as wished and do so to express a payload message through the particular order chosen. Or if no payload is added Alice will use randomness to build the definite order of C\hat{ }.

The reader will use the n keys to individually decrypt ciphertexts c₁, c₂, . . . cₙ to the corresponding plaintext message m₁, m₂, . . . mₙ, then concatenate the mᵢ message to M and thereby hold the original message M, Alice, the writer, prepared for submission in plain sight . . .

### Multi Lateral Deployment

The bilateral deployment can be readily expanded to a group of communicators sharing all or some of a set of n keys K₁, K₂, . . . Kₙ. Accordingly group members can communicate selectively among themselves, activating HIPS.

### Broadcasting

Alice and Bob can communicate through HIPS in a broadcasting mode.

Alice broadcasts a blog, a message board, a website content—using HIPS processors. The cyber space public is downloading, reviewing, interpreting the HIPS packages and for most of the readers there is nothing more than what the plain broadcast message says.

For Bob though that podcast is regarded as armed communication, containing the clear text (the plain message) and hiding the shared secret between him and Alice. The hiding is through writing and interpreting the particular order of letters in CA.

This way Bob will be receiving messages from Alice. Since Bob does what so many online surfers do—download Alice's podcast, there is no indication that Bob is the target of the HIPS secret. Bob in turn may either send Alice messages, or to be more obscure Bob will broadcast his own podcast which many in cyber space will download—including Alice. Bob will inject his payload into his podcast content and thereby send messages to Alice.

In summary, with both Alice and Bob broadcasting to the world, and both downloading each other broadcast, the two can communicate in a way which is hidden in plain sight. There is no indication that they are talking with each other because the podcasts they put forth are being used and downloaded by many others in cyberspace. The HIPS aim is achieved—the communication is properly hidden.

### Keys Visibility

In the basic deployment the keys of the decoy tolerant ciphers are packed into the ciphertext to allow every one encountering the package to decrypt the messages into their original plaintext. However, this can be changed. The keys can be withheld—some or all, from one, few or all of the intended recipients, thereby security can be managed.

### Encapsulation

Hidden in Plain Sight (HIPS) cryptography is essentially

1. A cryptographic method called “Hiding in Plain Sight”, HIPS, used by a transmitter and a message recipient where both are remotely connected over cyber space, and wherein a non-secretive text, “clear text”, contains a secret message called “payload” (π) and where being clear text, it draws no attention to the payload, thereby allowing for transmission of secret messages where neither the content, nor the fact of the transmission is exposed to an adversary;
HIPS operates as follows:
Let M be a clear text message comprising 2n letters of a given alphabet α, let M₁ be the message written as the first n letters in M, and let M₂ be the message written as the last n letters in M,
let DTC be a “Decoy Tolerant Cipher” which is a cipher operating over a, through a key K, and that distinguishes between (i) a ciphertext letter that is to be decrypted to its generating plaintext letter, and (ii) a decoy ciphertext letter which does not decrypt to any letter in α when decrypt-processed with key K;
let M₁ be DTC-encrypted with K₁ to the corresponding ciphertext C₁ comprising n ciphertext letters, each by order decrypts to its corresponding letter in M₁,
let M₂ be DTC-encrypted with K₂ to the corresponding ciphertext C₂ comprising n ciphertext letters, each by order decrypts to its corresponding letter in M₂.
let the payload be written as a bit string containing n bits;
the transmitter builds a composite ciphertext CC by concatenating individual ciphertext letters from C₁ and C₂, as follows:
defining:
(i) πᵢ as the i-th bit in π,
(ii) c₁ᵢ as the i-th letter in C₁
(iii) c₂ᵢ as the i-th letter in C₂
(iv) ccᵢ as the i-th letter in CC
   constructing CC by taking letters from C₁ and from C₂ according to the following rule:
given the CC being constructed by moving letters from C₁ and C₂ one after the other concatenating one by one, and given a state of CC where it is constructed from q letters from C₁ and r letters from C₂, then setting the q+r+1 letter in CC to comply with:

$$If {π}_{q + r + 1} = 0 then {cc}_{q + r + 1} = {c}_{1 q + 1}$$

$$If {π}_{q + r + 1} = 1 then {cc}_{q + r + 1} = {c}_{2 r + 1}$$

for q=1, 2, . . . and r=1, 2, . . . until q+r=n,
and from that state on, CC is constructed by randomly selecting the remaining letters from C₁ and C₂, until all the letters in C₁ and C₂ have been moved to construct CC;
preparing a ciphertext package containing CC and K₁ and K₂, sending it to the recipient over insecure channel,
the recipient decrypting CC first via K₁ to M₁, then via K₂ to M₂, then constructing M by concatenating M₁ and M₂:M=M₁∥M₂ thereby re-constructing the clear text message M,
then constructing x as follows: for i=1, 2, . . . n

$$If {cc}_{i} = {c}_{1 j} , for some j = 1 , 2 … n then {π}_{i} = 0$$

$$If {cc}_{i} = {c}_{2 j} , for some j = 1 , 2 … n then {π}_{i} = 1$$

thereby x is constructed by the recipient which concludes a HIPS round.

2. The method in paragraph 1 wherein the payload is a ciphertext generated by a DTC from a secret plaintext, “The HIPS secret”, by using a Payload-DTC key Kπ;
alternatively the payload is decoy ciphertext that when decrypted with Kππpoints to no plaintext;
where in the first option the communication package is regarded as “armed” and in the second option the communication package is regarded as “empty”;
the Payload-DTC and Kπ are shared between the recipient and the transmitter;

3. The method of paragraph 2 wherein the transmitter executes t successive HIPS rounds, most of them empty and a minority of them armed; an attacker will decrypt CC into M using K₁, K₂ which are part of the ciphertext package, but will have no indication which of the HIPS rounds is armed and which are empty.

4 The method of paragraph 1 wherein the clear text is written by the transmitter to either send to the recipient messages for which no secrecy is required, or the clear text is written to send to the recipient messages that would draw no suspicion to be hiding a secret—look innocent—serving the normal exchange between the communicators, when observed by an adversarial cryptanalyst, but these clear text messages only serve as a “blanket” to wrap in it the messages carried by the payloads, and their content is of no interest to the recipient.

5. The method of paragraph 1 wherein the clear text is written by an artificial intelligence, AI module that is trained in the normal communication between the transmitter and the recipient, and generates a clear text designed not to draw suspicion for a presence of hidden payload.

6. The method of paragraph 1 wherein two communicators are sending each other clear texts wherein no proper payload is used, and a random numbers generator is used to generate a fake payload, these rounds of communications render the communicators ready to use armed.

7. The method of paragraph 2 wherein normal messaging tools, email, phone messaging are operated in the HIPS mode, so a large number of the members of the text messaging public is using it, wherein the overwhelming majority of the HIPS rounds are empty, and only a small minority of the HIPS rounds are armed.

8. The method of paragraph 1 applied in a conversation mode wherein a group G of g parties
(i) share a payload-DTC key
(ii) establish an extensive cross messaging environment within G wherein they run conversations through the HIPS protocol, exchanging clear text messages that require no secrecy, and use a large plurality of empty rounds
(iii) use armed rounds in a minority of HIPS rounds within G without drawing suspicion from an observing adversary.

9. The method in paragraph 8 exercised in broadcast mode wherein party i, i=1, 2, . . . g broadcasts clear text i that is downloaded by a multitude of online readers, which are not in G but among them are the parties in G who share an agreed-upon Payload-DTC and a respective Kπ;
clear text i is comprising a majority of empty HIPS rounds, and a minority of armed rounds which the other parties in G detect and properly interpret;
party j, j=1, 2, . . . g. j≠i is responding to a payload sent by party i, by broadcasting clear text j that is downloaded by a multitude of online readers among them the parties in G; the parties in G properly interpret the payload from party j,
thereby the group G is exercising a clear text conversation while also conducting a HIPS conversation for which neither the contents nor the fact of its occurrence is visible by other than the members of G.

A second HIPS solution is essentially:

10. A method for a hidden in plain sight (HIPS) cryptography called flat-decoy, based on successively slicing a secret message, called payload, to s slices, and injecting between the slices decoy bits so that the combined bit string of the slices and the decoy bits, the loaded facade is interpreted as a common message expected between the transmitter and the recipient,
the recipient knows which of the bits in the loaded facade are the successive slices, which the recipient then concatenates in order to read the payload,
a recipient of the loaded facade who does not know where the slices are, and does not know whether there are slices, will not be able to extract the payload from the loaded facade.

11. The method in paragraph 10 wherein the payload is either a ciphertext of a Payload-DTC decrypting to a “secret message hidden in plain sight” SM-HIPS with a Payload-DTC key Kπ or is decoy ciphertext that when decrypted with Kπ points to no plaintext;
where in case of the first option the communication package is regarded as “armed” and in the case of the second option the communication package is regarded as “empty”;
the Payload-DTC and Kπ are shared between the recipient and the transmitter.

12. The method of paragraph 10 wherein the payload comprises st bits, and is divided to t slices of size s bits each, and between any two successive slices d decoy bits are being entered so that the loaded facade is properly interpreted by the recipient who will extract the t slices, then concatenate them to the payload.

13. The method of paragraph 10 wherein the slices are small enough and spread far enough from each other so that an artificial intelligence, AI module, can in a timely manner construct a loaded facade.

14. The method of paragraph 10 applied in a conversation mode wherein a group G of g parties
(i) share a payload-DTC key
(ii) establish an extensive cross messaging environment within G wherein they run conversations through the HIPS protocol, exchanging messages that require no secrecy, and use a large plurality of empty rounds
(iii) use armed communication in a minority of HIPS rounds within G without drawing suspicion from an observing adversary.

15. The method in paragraph 14 exercised in broadcast mode wherein party i, i=1, 2, . . . g broadcasts clear text i that is downloaded by a multitude of online readers, which are not in G but among them are the parties in G who share an-agreed upon Payload-DTC and a respective Kπ;
clear text i is comprising a majority of empty HIPS rounds, and a minority of armed rounds which the other parties in G detect and properly interpret;
party j, j=1, 2, . . . g. j #i is responding to a payload sent by party i, by broadcasting clear text j that is downloaded by a multitude of online readers among them the parties in G; the parties in G properly interpret the payload from party j,
thereby group G is exercising a clear text conversation while also conducting a HIPS conversation for which neither the contents nor the fact of its occurrence is visible by other than the members of G.

### REFERENCE

Decoy tolerant ciphers are very common among pattern devoid ciphers (PDC), for example BitFlip. For reference check: Open access peer-reviewed chapter
“Pattern Devoid Cryptography” Gideon Samid Reviewed: 25 Jul. 2023 Published: 14 Dec. 2023. DOI: 10.5772/intechopen.112660 https://www.intechopen.com/online-first/pattern-devoid-cryptography

What is claimed is:

1. A cryptographic method called “Hiding in Plain Sight”, HIPS, used by a transmitter and a message recipient where both are remotely connected over cyber space, and wherein a non-secretive text, “clear text”, contains a secret message called “payload” (x) and where being clear text, it draws no attention to the payload, thereby allowing for transmission of secret messages where neither the content, nor the fact of the transmission is exposed to an adversary;
HIPS operates as follows:
Let M be a clear text message comprising 2n letters of a given alphabet α, let M₁ be the message written as the first n letters in M, and let M₂ be the message written as the last n letters in M,
let DTC be a “Decoy Tolerant Cipher” which is a cipher operating over a, through a key K, and that distinguishes between (i) a ciphertext letter that is to be decrypted to its generating plaintext letter, and (ii) a decoy ciphertext letter which does not decrypt to any letter in α when decrypt-processed with key K;
let M₁ be DTC-encrypted with K₁ to the corresponding ciphertext C₁ comprising n ciphertext letters, each by order decrypts to its corresponding letter in M₁,
let M₂ be DTC-encrypted with K₂ to the corresponding ciphertext C₂ comprising n ciphertext letters, each by order decrypts to its corresponding letter in M₂,
let the payload be written as a bit string containing n bits;
the transmitter builds a composite ciphertext CC by concatenating individual ciphertext letters from C₁ and C₂, as follows:
defining:
(i) πᵢ as the i-th bit in π,
(ii) c₁ᵢ as the i-th letter in C₁
(iii) c₂ᵢ as the i-th letter in C₂
(iv) ccᵢ as the i-th letter in CC
constructing CC by taking letters from C₁ and from C₂ according to the following rule:
given the CC being constructed by moving letters from C₁ and C₂ one after the other concatenating one by one, and given a state of CC where it is constructed from q letters from C₁ and r letters from C₂, then setting the q+r+1 letter in CC to comply with:
$$If {π}_{q + r + 1} = 0 then {cc}_{q + r + 1} = {c}_{1 q + 1}$$
$$If {π}_{q + r + 1} = 1 then {cc}_{q + r + 1} = {c}_{2 r + 1}$$
for q=1, 2, . . . and r=1, 2, . . . until q+r=n,
and from that state on, CC is constructed by randomly selecting the remaining letters from C₁ and C₂, until all the letters in C₁ and C₂ have been moved to construct CC;
preparing a ciphertext package containing CC and K₁ and K₂, sending it to the recipient over insecure channel,
the recipient decrypting CC first via K₁ to M₁, then via K₂ to M₂, then constructing M by concatenating M₁ and M₂: M=M₁∥M₂ thereby re-constructing the clear text message M,
then constructing π as follows: for i=1, 2, . . . n
$$If {cc}_{i} = {c}_{1 j} for some j = 1 , 2 … n then {π}_{i} = 0$$
$$If {cc}_{i} = {c}_{2 j} for some j = 1 , 2 … n then {π}_{i} = 1$$
thereby π is constructed by the recipient which concludes a HIPS round.

2. The method in claim 1 wherein the payload is a ciphertext generated by a DTC from a secret plaintext, “The HIPS secret”, by using a Payload-DTC key Kπ;
alternatively the payload is decoy ciphertext that when decrypted with Kπ points to no plaintext;
where in the first option the communication package is regarded as “armed” and in the second option the communication package is regarded as “empty”;
the Payload-DTC and Kπ are shared between the recipient and the transmitter.

3. The method of claim 2 wherein the transmitter executes t successive HIPS rounds, most of them empty and a minority of them armed; an attacker will decrypt CC into M using K₁, K₂ which are part of the ciphertext package, but will have no indication which of the HIPS rounds is armed and which are empty.

4. The method of claim 1 wherein the clear text is written by the transmitter to either send to the recipient messages for which no secrecy is required, or the clear text is written to send to the recipient messages that would draw no suspicion to be hiding a secret—look innocent—serving the normal exchange between the communicators, when observed by an adversarial cryptanalyst, but these clear text messages only serve as a “blanket” to wrap in it the messages carried by the payloads, and their content is of no interest to the recipient.

5. The method of claim 1 wherein the clear text is written by an artificial intelligence, AI module that is trained in the normal communication between the transmitter and the recipient, and generates a clear text designed not to draw suspicion for a presence of hidden payload.

6. The method of claim 1 wherein two communicators are sending each other clear texts wherein no proper payload is used, and a random numbers generator is used to generate a fake payload, these rounds of communications render the communicators ready to use armed.

7. The method of claim 2 wherein normal messaging tools, email, phone messaging are operated in the HIPS mode, so a large number of the members of the text messaging public is using it, wherein the overwhelming majority of the HIPS rounds are empty, and only a small minority of the HIPS rounds are armed.

8. The method of claim 1 applied in a conversation mode wherein a group G of g parties
(i) share a payload-DTC key
(ii) establish an extensive cross messaging environment within G wherein they run conversations through the HIPS protocol, exchanging clear text messages that require no secrecy, and use a large plurality of empty rounds
(iii) use armed rounds in a minority of HIPS rounds within G without drawing suspicion from an observing adversary.

9. The method in claim 8 exercised in broadcast mode wherein party i, i=1, 2, . . . g broadcasts clear text i that is downloaded by a multitude of online readers, which are not in G but among them are the parties in G who share an agreed-upon Payload-DTC and a respective Kπ;
clear text i is comprising a majority of empty HIPS rounds, and a minority of armed rounds which the other parties in G detect and properly interpret;
party j, j=1, 2, . . . g. j≠i is responding to a payload sent by party i, by broadcasting clear text j that is downloaded by a multitude of online readers among them the parties in G; the parties in G properly interpret the payload from party j,
thereby the group G is exercising a clear text conversation while also conducting a HIPS conversation for which neither the contents nor the fact of its occurrence is visible by other than the members of G.

10. A method for a hidden in plain sight (HIPS) cryptography called flat-decoy, based on successively slicing a secret message, called payload, to s slices, and injecting between the slices decoy bits so that the combined bit string of the slices and the decoy bits, the loaded facade is interpreted as a common message expected between the transmitter and the recipient,
the recipient knows which of the bits in the loaded facade are the successive slices, which the recipient then concatenates in order to read the payload,
a recipient of the loaded facade who does not know where the slices are, and does not know whether there are slices, will not be able to extract the payload from the loaded facade.

11. The method in claim 10 wherein the payload is either a ciphertext of a Payload-DTC decrypting to a “secret message hidden in plain sight” SM-HIPS with a Payload-DTC key Kπ or is decoy ciphertext that when decrypted with Kπ points to no plaintext;
where in case of the first option the communication package is regarded as “armed” and in the case of the second option the communication package is regarded as “empty”;
the Payload-DTC and Kπ are shared between the recipient and the transmitter.

12. The method of claim 10 wherein the payload comprises st bits, and is divided to t slices of size s bits each, and between any two successive slices d decoy bits are being entered so that the loaded facade is properly interpreted by the recipient who will extract the t slices, then concatenate them to the payload.

13. The method of claim 10 wherein the slices are small enough and spread far enough from each other so that an artificial intelligence, AI module, can in a timely manner construct a loaded facade.

14. The method of claim 10 applied in a conversation mode wherein a group G of g parties
(i) share a payload-DTC key
(ii) establish an extensive cross messaging environment within G wherein they run conversations through the HIPS protocol, exchanging messages that require no secrecy, and use a large plurality of empty rounds
(iii) use armed communication in a minority of HIPS rounds within G without drawing suspicion from an observing adversary.

15. The method in claim 14 exercised in broadcast mode wherein party i, i=1, 2, . . . g broadcasts clear text i that is downloaded by a multitude of online readers, which are not in G but among them are the parties in G who share an-agreed upon Payload-DTC and a respective Kπ;
clear text i is comprising a majority of empty HIPS rounds, and a minority of armed rounds which the other parties in G detect and properly interpret;
party j, j=1, 2, . . . g. j≠i is responding to a payload sent by party i, by broadcasting clear text j that is downloaded by a multitude of online readers among them the parties in G; the parties in G properly interpret the payload from party j,
thereby group G is exercising a clear text conversation while also conducting a HIPS conversation for which neither the contents nor the fact of its occurrence is visible by other than the members of G.
